(19) United States
(12) Patent Application Publication
(10) Pub. No.: US 2007/0102598 A1
(43) Pub. Date: May 10, 2007

(54) Vehicle hub support

(76) Inventor: Dennis C. Nichols, Basehor, KS (US)

Correspondence Address: WM BRUCE DAY;DAY LAW FIRM PC, SUITE 300, 4330 BELLEVIEW, KANSAS CITY, MO, 64111, US

(21) Appl. No.: 11/634,453

(22) Filed: Dec. 7, 2006

Related U.S. Application Data
(63) Continuation-in-part of application No. 11/078,613, filed on Mar. 11, 2005, now abandoned.

(51) Int. Cl. F16M 11/00; F16M 13/00; F16M 11/38

(52) U.S. Cl. 248/125.8; 248/166

(57) ABSTRACT

A device for elevating and supporting a vehicle by the wheel hubs includes spaced A frame arranged legs and a top mounting bracket with holes for bolts to attach to the hub. Pivotally mounted feet adapt to the ground surface, and a removable crossbar holds the legs in a set angle. The device is foldable for portability.

### RELATED APPLICATION

This is a continuation in part of application Ser. No. 11/078,613 filed Mar. 11, 2005

### FIELD OF THE INVENTION

This invention relates to vehicle support stands and more specifically, to those supports that hold a vehicle by the hub in an elevated position for maintenance.

### BACKGROUND OF THE INVENTION

Vehicles such as cars and trucks must be elevated for access to the vehicle underside. While professional shops have large, floor mounted lifts, the home do it yourselfer is usually limited to a jack and jack stands. Certain hub stands have been used for years and are used by first jacking the vehicle, then bolting the hub stand to the hub. Known hub stands are bulky, non-foldable and have limited applications.

Prior vehicle support devices, such as Pitt U.S. Pat. No. 1,640,293 are known in the art but are not seen to provide the structural advantages of applicant's invention.

The present invention is intended to be a hub support stand which solves previous deficiencies in hub stands. It is foldable, sturdy, efficient, and believed to be safe under all known normal conditions of use.

### OBJECTS OF THE INVENTION

The objects of the present invention are:

To provide an improved hub support stand;

To provide such a hub support stand which is foldable and safe in use for all known conditions of use;

To provide such a hub support stand which is easy to store; and

To provide such a hub support stand that is economical of manufacture and well designed for the intended purpose.

### SUMMARY OF THE INVENTION

The hub stand is comprised of a top mounting plate which is universally connectible to vehicle hubs by stud bolts, and a pair of legs spread in A fashion. The legs have bottom foot pads and a crossbar that is attached to the legs by removable pins. The size and strength of the hub stand is commensurate with the vehicle to be supported.

### BRIEF DESCRIPTION OF THE DRAWINGS

FIG. 1 is a side elevational view of a hub support stand embodying the invention.

FIG. 2 is a top planar view of the hub support stand.

FIG. 3 is a side elevational view showing the hub support stand in relation to a vehicle hub.

FIG. 4 is a perspective view showing a packer panel within the cotton handler lift basket.

FIG. 5 is a perspective view showing details of the packer panel.

### DESCRIPTION OF THE PREFERRED AND ALTERNATE EMBODIMENTS

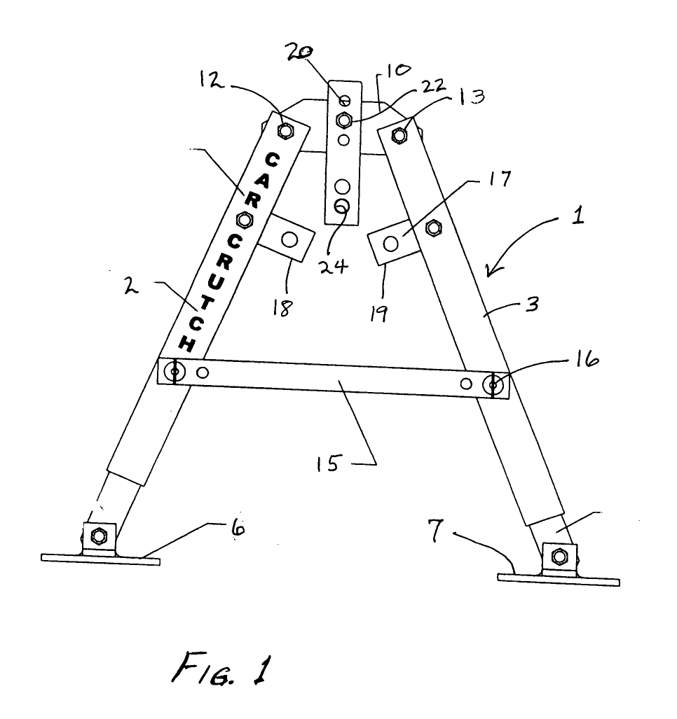

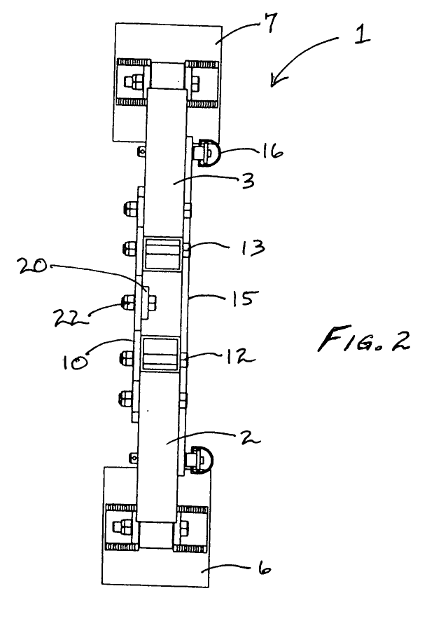

Referring to FIG. 1, the reference numeral 1 generally designates a vehicle hub stand embodying the invention. The stand 1 is preferably formed of steel bar stock of sufficient strength to support a vehicle and generally consists of a pair of spread apart legs 2 and 3 diverging in an “A” form. The legs 2 and 3 are telescoping square channel stock and terminate at lower ends in pivotally mounted foot pads 6 and 7. The foot pads are flat stock but may be formed with rollers for moving a vehicle supported by the stand 1.

Upper ends of the legs 2 and 3 are joined by a flat stock connecting plate 10 and pivot on bolts 12 and 13 for folding the legs 2 and 3 together. A crossbar 15 extends across midsections of the legs 2 and 3 and is connected by removable fasteners such as push-pull pins 16, which prevents the legs from spreading further apart than allowed by the crossbar 15. A hub mounting arrangement 17 is provided at the top of the stand 1. In the illustrated example, tabs 18 and 19 extend inwardly from the arms 2 and 3 and have holes to fit hub stud bolts through them and into a vehicle hub. A universal bracket 20 connects to the connecting plate 10 by a removable bolt 22 and includes a plurality of holes 24 suitable for connecting a bolt to a wide variety of vehicle hubs. Alternate holes in the crossbar 15 and bracket 20 allow the stand 1 to be adjusted to fit substantially any hub type.

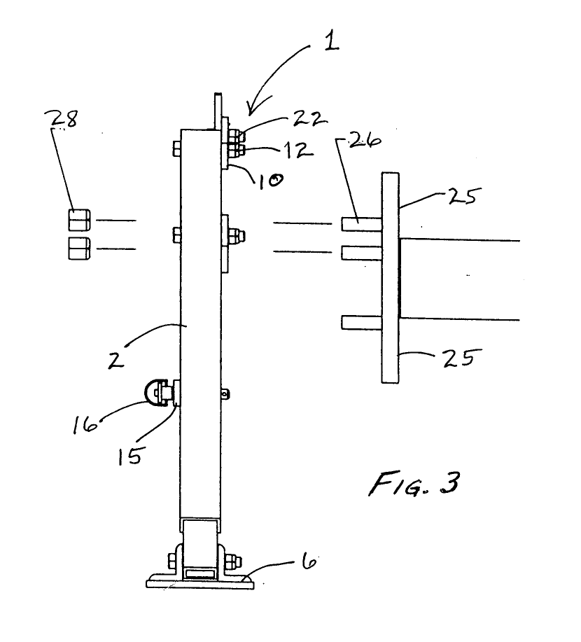

In use, FIG. 3, the stand 1 is adjusted so that either studs 26 or bolt holes in a vehicle hub 25 are aligned, the stand mounted against the hub and secured by nuts 28.

The stand is height adjustable by the use of telescoping square tubing in the legs secured by hole and pin means. The height adjust provides versatility in use. As an alternative, the foot pads 6 and 7 can be fitted with rollers to allow rolling the car on stands about a work area floor. Sleeves of hardened material or of smooth bearing material may be provided around all rotational connections to provide smooth operation and long life. The bottom of the foot pads may be faced with non-slip material. All these modifications and more are within the scope of the invention, the scope to be limited only by the claims set forth.

What is claimed and desired to be secured by Letters Patent is:

1. A vehicle hub stand for attachment to a hub for supporting a vehicle above a floor surface and comprising:
a) spaced support legs arranged in A frame manner and having lower end foot pads and upper ends swingably joined to a top connection;
b) a crossbar removable mounted to the legs maintaining the legs in spread, supporting relation; and
c) a universal bracket arranged at upper portions of the legs and the top connection and adapted for connection to a variety of different vehicle hubs.

2. The vehicle hub stand set forth in claim 1 wherein said legs are telescopically adjustable in height.

3. The vehicle hub stand set forth in claim 1 where said footpads are swingably mounted to said legs.

4. The vehicle hub stand set forth in claim 1 wherein said universal bracket has a plurality of holes therethrough for fitting studs and bolts connectible to a hub.

5. A vehicle hub stand for attachment to a hub for supporting a vehicle above a floor surface and comprising:
a) spaced support legs arranged in A frame manner and having lower end feet and upper ends joined by a connector permitting folding of said legs together, the legs being telescopically adjustable for varying height of the hub stand;
b) a crossbar swingably and at least partially removable from said support legs and when connected, extending between said legs and maintaining said legs in spaced A frame configuration; and
c) a universal hub mounting bracket adaptable to varying vehicle hubs and mounted to said support legs at upper portions thereof.
